(19) United States
(12) Patent Application Publication
(10) Pub. No.: US 2016/0188937 A1
(43) Pub. Date: Jun. 30, 2016

(54) UNIVERSAL ASSAY READER

(71) Applicant: EXPRESS DIAGNOSTICS INT'L., INC., Blue Earth, MN (US)

(72) Inventors: Steven Patrick TYRRELL, Erie, CO (US); Bary Patrick VANT-HULL, Boulder, CO (US)

(21) Appl. No.: 14/909,445

(22) PCT Filed: Jul. 30, 2014
(86) PCT No.: PCT/US2014/000173

§ 371 Date: Feb. 1, 2016

Related U.S. Application Data
(60) Provisional application No. 61/860,238, filed on Jul. 30, 2013.

(51) Int. Cl. G06K 7/10; G01N 35/00; G06K 9/46; G06K 7/14; G06T 7/00

(52) U.S. Cl. CPC G06K 7/10722; G06K 7/1413; G06K 7/1417; G06T 7/0012; G06T 7/0081; G06K 9/4661; G01N 35/00029; G01N 35/00693; G01N 35/00732; G01N 2035/00118; G01N 2035/00702; G01N 2035/00831; G01N 2035/00752

(57) ABSTRACT

A universal assay reader comprising a base, a shroud, a camera, and an illumination source. The base has a receiver for receiving sample containers with assay strips, the receiver having a plurality of form fit patterns for receiving and seating more than one type of configured container or assay device. A method of using the assay reader to perform an assay includes identifying a received assay device, retrieving image data of the device, adjusting a light exposure, capturing an image of a portion of the assay device and a portion of the background, the background including an image of a portion of the shroud. Analyzing the captured image includes performing a registration process to determine an angle of rotation and distance offsets of the device with respect to an expected position, and determining the presence or absence of an indicator line in a region of interest of the captured image.

### PRIORITY CLAIM

The present application claims the benefit of U.S. Provisional Application No. 61/860,238 entitled AUTOMATED ELECTRONIC IMAGE DETECTION OF NEGATIVE OR POSITIVE LATERAL FLOW TEST STRIP RESULTS, filed Jul. 30, 2013, and which is incorporated herein by reference in its entirety.

### FIELD OF THE INVENTION

The present invention is generally directed to assay reader units, systems and methods. More specifically, the present invention is directed to universal automated assay reader units configured to receive a wide variety of assay devices, and associated methods for automatically reading and analyzing such a wide variety of assay devices.

### BACKGROUND OF THE INVENTION

Assay reader units utilize imaging technologies to machine read results of visual indicators of assay strips, in particular lateral flow assay strips. Typically the containment that includes the assay strips is a specimen container and needs to be adapted specifically for the reader unit. In other readers, only one strip can be read at a time. This limits their flexibility and potential uses. It would be beneficial to provide a more universal assay strip reader.

Further, automated, universal methods of reading a wide variety of containers and devices would be beneficial.

### SUMMARY OF THE INVENTION

In embodiments of the invention, an assay strip reader has a base, a universal receiver with a receiving region for receiving differently configured sample containers with exposed assay strips, a camera that looks towards generally horizontally toward the receiving region, internal illumination source and a shroud. The universal receiver may be removable from the base to provide alternate receivers for other differently configured containers. In embodiments, the shroud may pivot to swing upwardly and rearwardly exposing the receiver. In other embodiments the shroud may be entirely removed.

Another embodiment comprises a method of automatically performing an assay, the method comprising: receiving an assay device into an interior of an assay reader unit; automatically identifying an assay device having a plurality of test strips, each test strip configured to test for the presence or absence of a test drug; retrieving assay device image data stored in a memory device; exposing a portion of the assay device to light emitted by an imaging unit of the assay reader unit; adjusting the light exposed to the portion of the assay device based upon a measured exposure level within the interior of the assay reader unit and a predetermined exposure level associated with the assay device; capturing an image of the portion of the assay device and a portion of a background; performing a registration process to determine an angular orientation of the assay device; rotating the image of the portion of the assay device and a portion of the background; determining a set of distance offsets, the distance offsets defining a deviation in a position of an image of the portion of the assay device relative to an expected position; using the distance offsets to select a read window, the read window defining a pixel matrix having pixel intensity data; analyzing the pixel intensity data to determine the presence of an indicator line, the presence of an indicator line indicating an absence of the test drug.

Another embodiment comprises an assay reader system, comprising: an assay device having a plurality assay test strips; and an assay reader unit, the assay reader unit including: a processor; an imaging unit for imaging a portion of the assay device, the imaging unit communicatively coupled to the processor, a user interface for receiving input from a user of the assay reader unit, the imaging unit communicatively coupled to the processor; a memory storing image data associated with the assay device, the memory communicatively coupled to the processor; wherein the processor is configured to: identify the assay device; cause the imaging unit to expose the assay device to light emitted by the imaging unit; cause the imaging unit to capture and store an image of a portion of the assay device and a portion of a background of the assay device, the background of the assay device comprising a shroud of the assay reader unit, the image defined by a set of pixel data; perform a registration process to determine an angle of rotation of the assay device within the assay reader device; and determine an image offset based on the angle of rotation, and use the image offset to determine a subset of pixel data to analyze for the presence or absence of an indicator line.

Another embodiment comprises an assay reader unit for receiving an assay device containing a plurality of assay test strips, comprising: a processor; an imaging unit for imaging a portion of the assay device, the imaging unit communicatively coupled to the processor; a memory storing image data associated with the assay device, the memory communicatively coupled to the processor; wherein the processor is configured to: identify an assay device received by the assay reader unit; cause the imaging unit to expose the assay device to light emitted by the imaging unit; cause the imaging unit to capture and store an image of a portion of the assay device and a portion of a background of the assay device, the background of the assay device comprising a shroud of the assay reader unit, the image defined by a set of pixel data; perform a registration process to determine an angle of rotation of the assay device within the assay reader device; and determine an image offset based on the angle of rotation, and use the image offset to determine a subset of pixel data to analyze for the presence or absence of an indicator line.

Another embodiment comprises a method of adjusting a light exposure level received by an assay device housed within a fully enclosed interior space of an assay reader unit having a processor and an imaging unit, comprising: exposing the assay device to light emitted by the imaging unit; capturing an image of the exposed assay device, the image defined by an array of pixel data, the array of pixel data comprising an array of pixel intensity values; determining an average pixel intensity value for the image; comparing the average pixel intensity value to a predetermined average pixel intensity value specific to the assay device; adjusting the light exposure level at the assay device based upon the comparison of the average pixel intensity value of the image and the predetermined average pixel intensity value specific to the assay device.

Another embodiment comprises a method of registering an assay device positioned in a receiver of an assay reader unit, comprising: capturing a image of a portion of the assay device and a portion of a background of the assay device, the image including a device-image portion and a background portion; defining an x-y Cartesian coordinate system for defining a position of the device image relative to an edge of the image; determining an expected position of the device-image defined by a first set of coordinates of the coordinate system; and comparing a position of the device-image portion defined by a second set of coordinates to the first set of coordinates to determine a device-image angle of rotation.

Another embodiment comprises a method of determining a presence or absence of an indicator line in a captured image of a test strip, comprising: determining a read window defining a pixel array P[I,J] to be analyzed, the pixel array defined as having I rows and J columns and including intensity values for each pixel p(i,j) in the pixel array; comparing each pixel p(i,j) intensity value to pixel intensity value of a pixel p(i+θ,j) of a row above the pixel (i,j) and a pixel intensity value of a pixel p(i−θ,j) in a row below each pixel p(i,j); determining that a pixel p(i,j) is a valid pixel if the pixel p(i,j) intensity value is greater than the pixel intensity value of the pixel p(i+θ,j) and the pixel intensity value of the pixel p(i−θ,j); determining a ratio of valid pixels to not valid pixels in each row I; comparing the ratio of valid pixels to not valid pixels to a predetermined ratio, and determining that a row I is a valid row if the ratio is greater than or equal to the predetermined ratio, thereby determining a set of valid rows; identifying groups of contiguous valid rows; determining for each group of contiguous valid rows whether a quantity of valid lines in each identified group is equal to or greater than a predetermined quantity associated with the assay device to determine whether the group comprises a line; analyzing the intensity of pixels associated with the contiguous valid rows to determine whether the line is valid.

### BRIEF DESCRIPTION OF THE FIGURES

The invention can be understood in consideration of the following detailed description of various embodiments of the invention in connection with the accompanying drawings, in which:

FIG. 1 is a side elevational view of an assay reader unit according to the invention. The view from the opposite side being a mirror image thereof.

FIG. 2 is a perspective view from the front right side of the assay reader of FIG. 1. The view from the front left side being a mirror image thereof.

FIG. 3 is a perspective view from the back left side of the assay reader of FIG. 1. The view from the back right side being a mirror image thereof.

FIG. 4 is a side elevational view of the assay reader of FIG. 1 with a front portion of the shroud pivoted rearwardly exposing a sample container with assay strips.

FIG. 5 is front perspective view of the assay reader of FIG. 4 with the front portion of the shroud removed showing the camera and illumination sources.

FIG. 6 is a side perspective view of the assay reader of FIG. 5 with the shroud removed and illustrating how the sample container is received in the receiver.

FIG. 7 is a perspective view of the receiver of the assay reader of the above figures removed from the base.

FIG. 8 is a perspective looking downward illustrating registration surfaces for three differently configured sample receiving containers with assay strips.

FIG. 9 is a cross sectional view taken at line 99 of FIG. 8.

FIG. 10 is a block diagram of a assay reader system, according to an embodiment.

FIG. 11 is a flow diagram of a process of performing an assay using the system of FIG. 10, according to an embodiment.

FIG. 12 is a flow diagram of an exposure adjustment step of the process of FIG. 10, according to an embodiment.

FIG. 13 is a flow diagram of a device registration process of the process of FIG. 10, according to an embodiment.

FIG. 14A is an illustration of a device-with-background image having a device portion imaged at an expected position, according to an embodiment.

FIG. 14B is an illustration of the device-with-background image of FIG. 14A with a set of registration points overlaying the image, according to an embodiment.

FIG. 14C is an illustration of a device-with-background image having a device portion located at an actual position that is different from the expected position of FIG. 14A, according to an embodiment.

FIG. 14D is an illustration of the device-with-background image of FIG. 14A in a rotated position, according to an embodiment.

FIG. 14E is an illustration of the device-with-background image of FIG. 14A in an offset position, according to an embodiment.

FIG. 15 is a flow diagram of a line-detection method of the process of FIG. 11, according to an embodiment.

FIG. 16 is a flow diagram of a read-window line-detection method of the process of FIG. 15, according to an embodiment.

FIG. 17 is an illustration of an image of an assay device and a pixelated read widow of a test strip of the assay device, according to an embodiment.

FIG. 18A is an illustration of the pixelated read window of FIG. 16.

FIG. 18B is an illustration of the pixelated read window of FIG. 18A after a first image-analysis step is performed.

FIG. 18C is an illustration of the pixelated read window of FIG. 18B after another image-analysis step is performed.

FIG. 18D is an illustration of the pixelated read window of FIG. 18C after another image-analysis step is performed.

FIG. 18E is an illustration of the pixelated read window of FIG. 18D after a final image-analysis step is performed.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

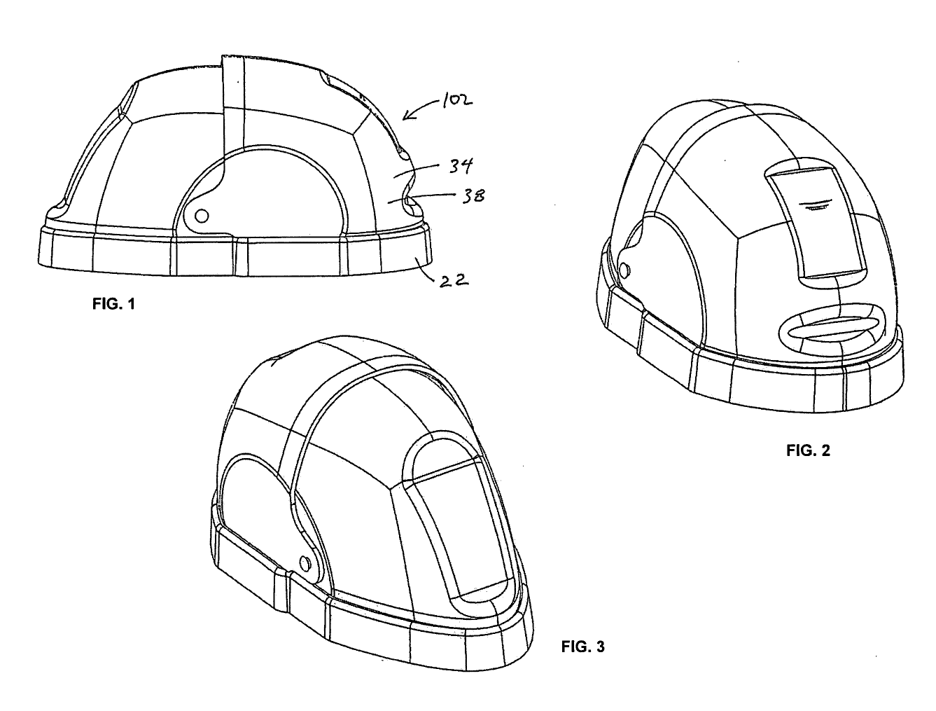

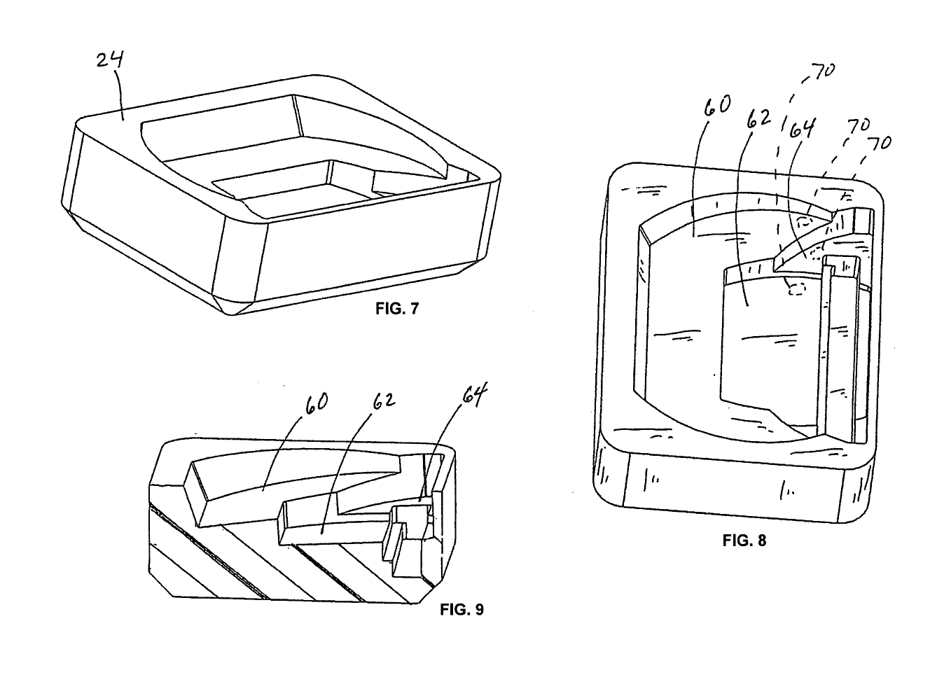

Referring to FIGS. 1-6, an assay reader unit 102 generally comprises a base 22, a sample container receiver 24, defining a receiving region 26, a camera support 28 and imaging unit or camera 30, illumination sources 32 and a shroud 34. A particularly configured sample container 36 with an assay strip reader window 37 is illustrated as it is received by the reader.

As illustrated the shroud may be removable or have a portion, such as the front portion 38, be pivotal about a pivot 40 to swing upwardly and rearwardly exposing the receiver. The shroud is generally an oblong dome shape but can of course be other shapes. The shroud, particularly removable or pivotal portions have a light sealing edge 46 that engages a cooperating surface 50 on the base to form a generally light tight enclosure when the shroud is in place. A sensor 54, such as optical, or presence sensors, capacitive sensors, or other sensors may be utilized to detect when the shroud is closed and signal a control processor or operator, for example to commence a reading process.

The base 22 supports the receiver 24, and camera support 28 and may contain electronic circuitry, including control processors as desired. The base may be injection molded of polymer, as can the other structural components. Apertures, or recesses can be provided for receiving the receiver and camera support.

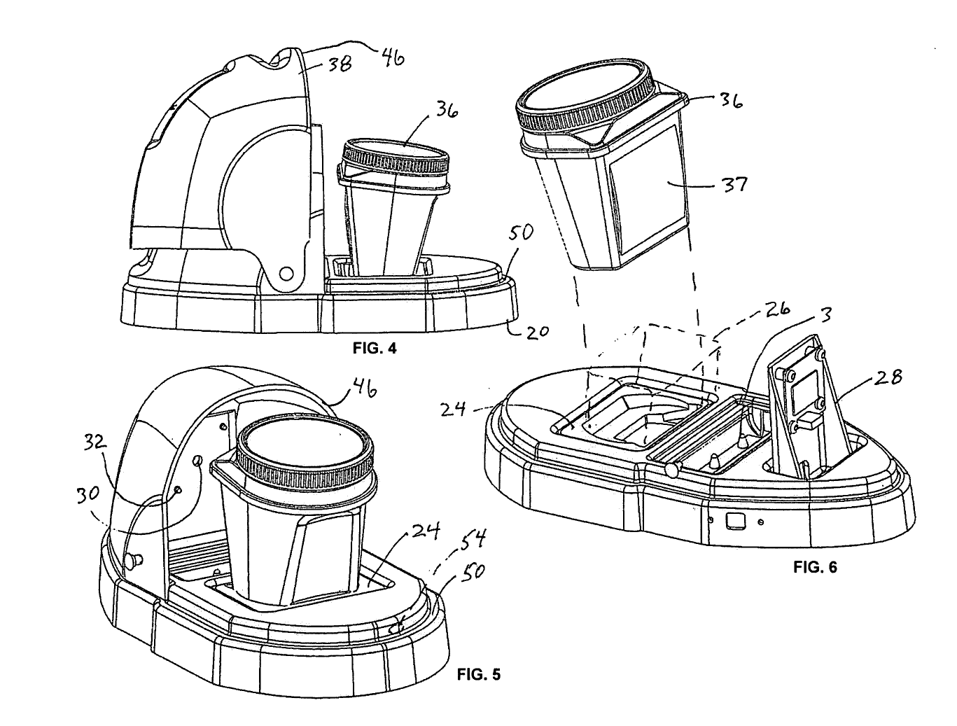

The universal receiver as illustrated in FIGS. 4-9, may be injection molded from polymers or machined from metals. The Base has distinct form fit patterns to receive a plurality of differently configured containers. In the example illustrated, three distinct sample containers may be received as illustrated by three different horizontal landings 60, 62, 64. The containers have integral test strips and may be configured for saliva, urine, or blood. The landings or other regions in the receiver may similarly have sensors 70 connected to the control processor or other suitable equipment to ascertain which of the variously configured containers is currently in place.

Apparatuses, systems, and methods described herein differ from, and improve upon, many of the of assay devices, automated methods of identifying assay devices, and automated assay reader units known in the art, including those described in patent publications: US 2013/0184188, filed on Dec. 21, 2012, and entitled “Integrated Test Device for Optical Detection of Microarrays”; U.S. Pat. No. 7,943,381, filed on Oct. 27, 2006, and entitled “Method for Testing Specimens Located at a Plurality of Service Sites”; U.S. Pat. No. 8,367,013, filed Dec. 24, 2001, and entitled “Reading Device, Method, and System for Conducting Lateral Flow Assays”; US 2013/0162981, filed Dec. 21, 2012, entitled “Reader Devices for Optical and Electrochemical Test Devices”; PCT Publication WO2011/044631, with a claimed priority date of Jul. 20, 2010, entitled “Optical Reader Systems and Lateral Flow Assays”, U.S. Pat. No. 8,698,881, filed Mar. 5, 2013, entitled “Apparatus, Method and Article to Perform Assays Using Assay Strips”, all of which are incorporated by reference herein in their entireties.

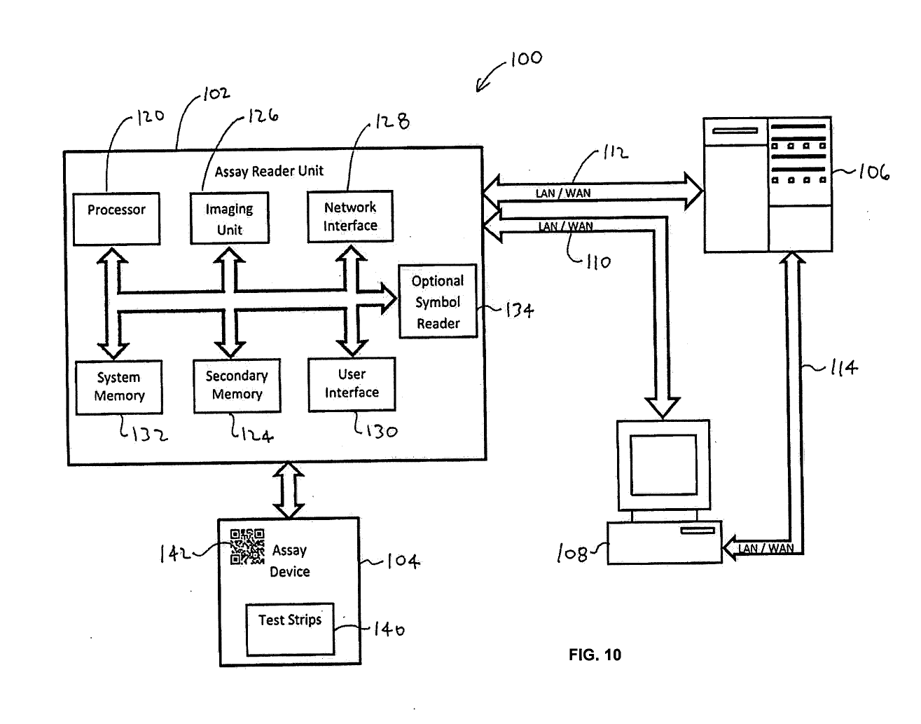

Referring to FIG. 10, an embodiment of an assay reader system 100 is depicted. In an embodiment, assay reader system 100 includes assay reader unit 102, assay device 104, optional computer 108, and optional computer serer 106. In the depicted embodiment, assay reader unit 102 communicates over network 110 to computer 108 and over network 112 to server 106, and computer 108 may communicate with server 106 over network 114.

In an embodiment, assay reader unit 102 may operate in a networked environment using logical connections to one or more remote computers and/or devices, such as peripheral computer 108 and computer server 106. Computer server 106 can be another peripheral computer, a server, another type of computer, or a collection of more than one computers communicatively linked together. Server 106 may be logically connected to one or more assay reader units 102 using any known method of permitting computers to communicate, such as through one or more LANs and/or WANs 110, 112, or 114, including the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

Although in the embodiment of FIG. 10, assay reader unit 102 is depicted as communicating over networks 110-114 to remote computing devices 106 and 108, in other embodiments, system 100 may not include networks 110-114, nor server 106 and computer 108. In such an embodiment, assay reader system 100 may only include assay reader unit 102 and assay device 104.

In an embodiment, assay reader unit 102 includes processor 120, system memory 122, secondary memory 124, imaging unit 126, network interface 128, interface 130, and system bus 134.

Processor 120, communicatively linked to other system components through system bus 134, can be any logic processing unit, such as one or more central processing units (CPUs), digital signal processors (DSPs), application-specific integrated circuits (ASICs), field programmable gate arrays (FPGAs), microcontroller, microprocessor, microcomputer, or other such processing or computing device.

In an embodiment, system memory 122 may comprise read-only memory (“ROM”) and/or random access memory (“RAM”). Program modules may be stored in system memory 122, such as an operating system, application programs, and program data. Program modules can include instructions for handling security such as password or access protection. System memory 122 can also include communications programs such as a web client or browser for enabling assay reader unit 102 to access and exchange data with sources such as websites of the Internet, corporate intranets, extranets, or other networks, as well as other server applications on server computing systems such as server 106.

In an embodiment, secondary memory 124 includes any of flash memory, hard disk and drive, optical disk and drive, magnetic disk and drive, and so on. An operating system, application programs, other programs, program data, other data, and a browser may be stored in secondary memory 124.

In an embodiment, imaging unit 126 is configured to capture images of assay device 104 and its test strips 140. Imaging unit 126 may take a variety of forms, and may include, for example, a digital still or video camera 30 (see also FIG. 5), one- or two-dimensional arrays of charge-coupled devices (CCD), CMOS sensors, analog video camera, and so on. In an embodiment, imaging unit 126 also includes an illumination source to illuminate assay device 104 and test strips 140. In one such embodiment, the illumination source may take the form of one or more lamps, such as one or more light-emitting diodes, one or more fluorescent lamps, and so on. A buffer (not shown) may buffer data from imaging unit 126 until processor 120 is ready to process available image data.

Network interface 128, linked to system bus 134, may include any of a variety of known systems, devices, or adapters for communicatively linking assay reader unit 102 to a LAN or WAN 110-112.

Interface 130 may comprise a user interface or a device or network interface coupled to system bus 134, including user-oriented devices such as a keyboard, keypad, display, mouse and so on, as well as device-oriented components such as ports, various adapters, wired and wireless connection systems, and so on.

When present, optional symbol reader 132 can take the form of a machine-readable symbol reader or scanner configured to optically (e.g., visible, infrared, ultraviolet wavelengths of electromagnetic energy) read information encoded in machine-readable symbol or code 142 (e.g., barcode symbols, QR codes, stacked code symbols, area or matrix code symbols) carried by assay device 104. In such an embodiment, reader 132 may include an information acquisition component or engine to optically acquire machine-readable symbol 142, such as a scan engine that scans machine-readable symbols using a narrow beam of light (e.g., laser scanner). Alternatively, reader 132 may take the form of an image-based reader that analyzes images captured by imaging unit 126.

In another alternate embodiment, reader 132 may take the form of one or more RFID readers operable to wirelessly read information encoded into one or more RFID transponders. In such an embodiment, reader 132 includes an information acquisition component or engine to wirelessly interrogate an RFID transponder and to receive information encoded in a response from the RFID transponder.

Reader 130 can be used to read machine-readable information carried by assay device 104 test strips 140, or other devices carrying a readable symbol or code 142 having information relating to device 104 or test strips 140.

Symbol or code 142 may comprise a label which is attached to the assay device 104. Alternatively, symbol 142 may be printed, engraved, etched, or otherwise applied to assay device 104 or its test strips 140, without the use of a tag or label. The machine-readable information of symbol 142 may include information identifying assay device 104 and/or test strips 140.

Server 106 includes server applications for the routing of instructions, programs, data and so on between assay reader unit 102 and remote devices, including peripheral computer 108.

Peripheral computer or computing system 108 may take the form of a workstation computer, peripheral computer (desktop or laptop), or handheld computer, including a PDA or smartphone. Peripheral computing system 108 may include its own processing unit, system memory and a system bus that couples various system components. In an embodiment, n operator can enter commands and information into peripheral computing system 108 via a user interface through input devices such as a touch screen or keyboard and/or a pointing device such as a mouse. Such commands and information may be communicated to assay reader unit 102, such that a user may interface with, and even control, assay reader unit 102 through computer 108, when assay reader unit 102 is operated in a networked environment.

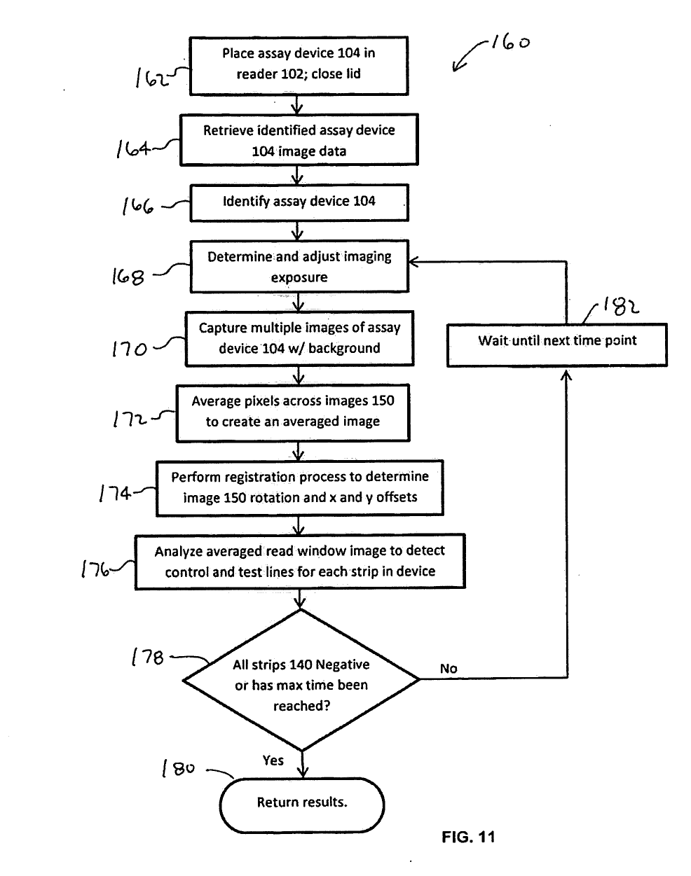

Referring also to the flow diagram of FIG. 11, a method of operation of assay reader system 100 and assay reader unit 102 is depicted and described.

At step 162, and as depicted and described above with respect to FIGS. 1-9, assay device 104 is placed in assay reader unit 102 with test strips 140 facing imaging unit 126, and shroud 34 is closed. Closing shroud 34 creates a dark environment for assay device 104.

At step 164, assay device 104 is identified by assay reader unit 102. Identification of assay device 104 may be accomplished with the interaction of a user, or automatically as described above.

In an embodiment, a user enters information identifying assay device 104 into assay reader unit 102 by way of interface 130. In one such embodiment, interface 130 comprises a keyboard, touch pad, or such input device for receiving information from the user. For example, a user may interface with assay reader unit 102 to input identifying information such as an assay device type, manufacturer, serial number, and so on. Inputted information may also include information identifying test strips 140 type, configuration, and so on. Alternatively, a user may select from one of multiple assay devices 104 as presented on a display of assay reader unit 102.

In an embodiment configured to operate in a networked environment, the user may operate peripheral computer 108 to interface with assay reader unit 102 to input information, or otherwise identify assay device 104.

In another embodiment, optional symbol reader 134 is utilized to identify assay device 104. In such an embodiment, symbol reader 134, which may be a scanner, optically scans or captures data from symbol 142 on assay device 104. In an embodiment, symbol reader 134 comprises an optical scanner, and symbol 142 comprises a machine-readable code, such as a QR or other matrix code. In one such embodiment, symbol reader 134 provides data captured from symbol or code 142 to processor 120, or imaging unit 130 provides data captured in image form, which determines a type of assay device from a database, look-up table, or other data store (such as one stored in secondary memory 124), to identify the assay device.

At step 166, image data associated with identified assay device 104 is retrieved. As will be described further below, in an embodiment, image data associated with identified assay device 104 may include any of expected device-image size, device-image dimensions, device-image location and orientation within a larger captured image, number of test strips expected in the image, individual test-strip image location and orientation, control line location, test line location, device-image exposure and other related image data.

Such data may be stored locally, such as in secondary memory 124 and retrievable from a database or other data structure stored in secondary memory 124. In other embodiments, device 104 image data may be retrieved from other memory storage devices, including remote memory associated with server 106 and/or computer 108. In such an embodiment, a database having image data for multiple types of assay devices 104 may be accessed by LAN or WAN.

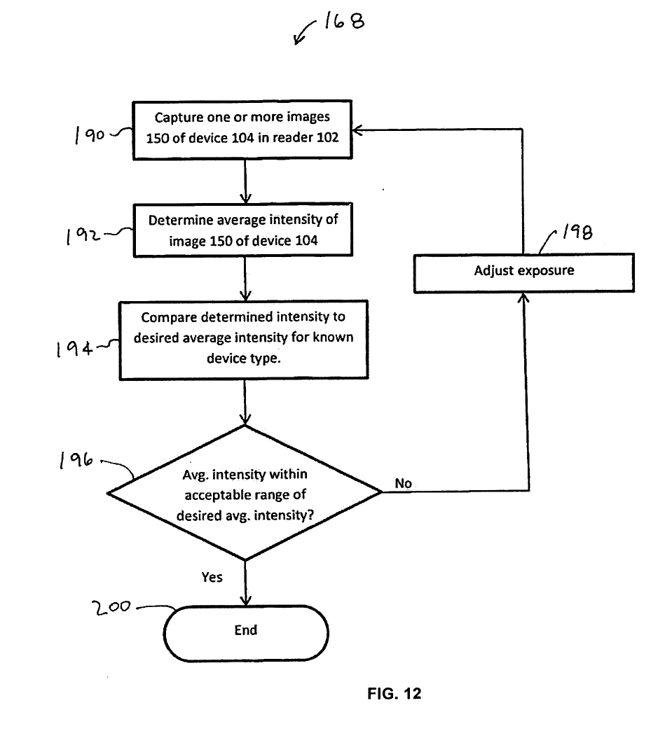

At step 168, the device-image exposure is determined and adjusted. The ability to adjust the exposure of the captured image of assay device 104 and its test strips enables more accurate detection of control and test lines, ensuring that assay reading unit 102 provides accurate test results. Step 168 is described in further detail below with respect to FIG. 12.

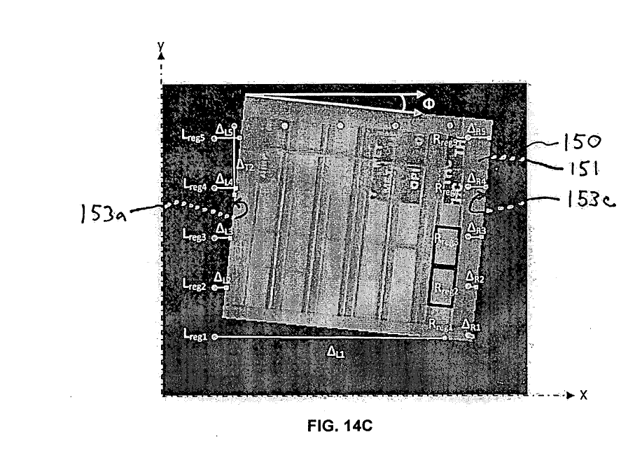

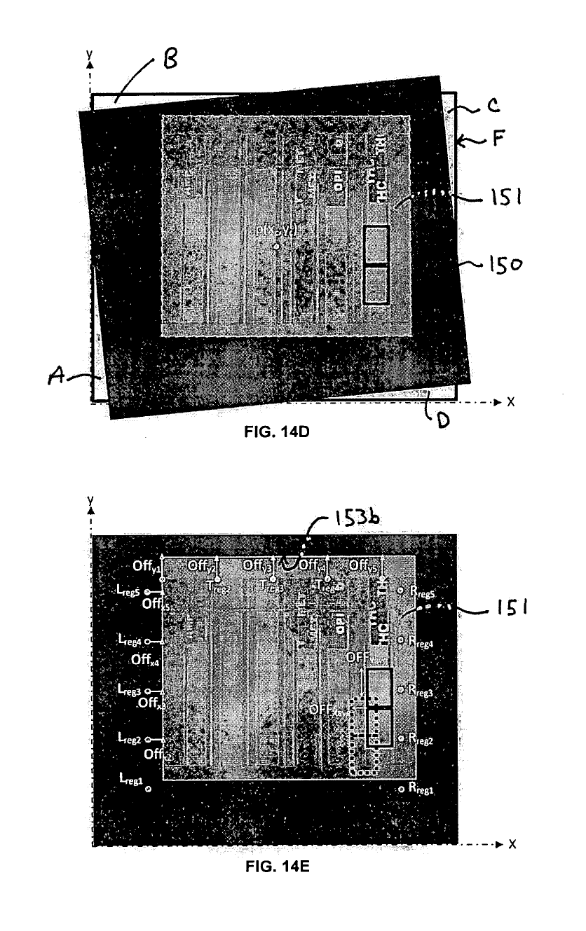

At step 170, one or more images of assay device 104 with test strips 140 and background portion, herein referred to as “device-with-background” image 150 (see FIG. 14A) are captured using imaging unit 126, and digitized if needed.

Referring also to FIG. 14A, device-with-background image 150 defines device image 151, background border 152 comprising left border 152a, top border 152b, right border 152c, and bottom border 152d, device-with-background image edges 153, comprising left image edge 153a, top image edge 153b, right image edge 153c and bottom image edge 153d, device-image edges 154a, 154b, 154c, and 154d, control read window 158, test read window 159, control line 161, test line 163, as well as test strip images 141 of test strips 140.

Device image 151 is defined by the portion of device-with-background image 150 that depicts all or a portion of assay device 104. In an embodiment, a bottom portion of assay device 104 is covered and cannot be imaged, such that device-image 151 captures only a portion of assay device 104.

Background border 152 comprising left border 152a, top border 152b, right border 152c, and bottom border 152d, and in an embodiment, appears generally as a black or dark border surrounding device image 151. Such a border is the result of imaging unit 126 exposing primarily assay image 104, rather than a surrounding housing or shroud 34 of assay reader unit 102.

Device-with-background image edges 153, comprising left image edge 153a, top image edge 153b, right image edge 153c and bottom image edge 153d, define the outermost edges of the entire captured image, i.e., a portion of the device and a background.

Device-image edges 154a, 154b, 154c, and 154d, define the edges of the image of assay device 104, namely, device-image 151. The spatial relationship between edges of image 150 and image 151 may be used to determine an actual position or location of assay device 104 in assay reader 102.

Control read window 158 is a predetermined area, or region of interest, of device-with-background image 150 (and device-image 151) surrounding a location of an expected control line 161. During an assay, a control line 161 should appear, or else the assay/test should be considered invalid.

Test read window 159 is a predetermined area, or region of interest, of device-with-background image 150 (and device-image 151) surrounding a location of an expected test line 163. In the case of a negative result (no test drug present), a test control line 163 will appear in a test read window 159.

As will be described further below with respect to FIG. 14A-14C, edges 154a-154d are used in an edge analysis to determine a relative position of assay device 102 within assay reader unit 102.

Digital data from each device-with-background image 150 is used to form a two-dimensional array of pixel data, P[I,J], having I rows and J columns for a total of “I” times “J” pixels. Each individual pixel p[i,j] is identified by its ith and jth coordinate in the matrix, and is represented by a data set that includes pixel intensity data, or data for deriving pixel intensity, such as an RGB (Red-Green-Blue) vector, as will be understood by those of skill in the art.

In an embodiment, the RGB color model is used to determine individual pixel intensity. However, it should be understood that method 160 could be used with any color model (CMYK, HSL, HSV, etc.) once the method for defining intensity is defined. In all of these color models, each pixel describes a vector of color components defined for that point or pixel. In the RGB model, these color components are Red, Green and Blue. If all three components are set to zero, the pixel is black, if all three are set to their maximum value (a typical maximum is 255), the pixel is white. Different combinations yield different colors at different intensities. In the RGB model, and in an embodiment, intensities can be calculated by averaging the three components (I=(R+B+G)/3). This is often called grayscaling, because if all three components are set to this average, a gray color is produced. It is important to realize that any method that converts the vector of color components to a single number could be used as alternative methods to determine intensity, and could therefore be used in method 160, and in particular at step 170. For instance, only the Red component could be used, ignoring the others (I=R). Or intensity could be calculated as “redness”, for example I=R−(B+G)/2.

In an embodiment, known methods of “grayscaling” are used to determine pixel intensities, and such data comprises the pixel data of array or matrix Pₙ[I,J]. In an embodiment, pixel intensity from the RGB vector is determined and assigned a value ranging from 0 to 255, and saved into the pixel data array P[I,J]. In other embodiments, an RGB color vector is saved into pixel array P[I,J].

At step 172, in an embodiment, and as depicted, the multiple device-with-background images 150 are captured, then individual pixel intensity data for each image 150 is averaged to ensure an accurate starting point for image and pixel analysis.

In an alternate embodiment, only one device-with-background image 150 is captured.

In a multiple image embodiment, corresponding pixels from a first image P₀[I,J] are averaged with pixel data from second image array P₁[I,J], and subsequent nth image arrays PₙI,J] to form an averaged pixelated image, P_{avg}[I,J]. For example, if four images 150 are captured, and pixel p₀[i,j]=0, p₁ [i,j]=2, p₂[i,j]=2, p₃[i,j]=0, then average pixel intensity p_{avg}(i,j)=1.

After each pixel set p₀(i,j) to pₙ(i,j) is averaged, a complete device image pixel matrix P[I,J] is available for analysis.

In an alternate embodiment, pixels identified as background pixels are not used in creating an averaged image P_{avg}[I,J], but rather, an image of all or portions of assay device 104 are analyzed without background.

At step 174, a registration process is performed to determine a device-with-background image 150 orientation, which in an embodiment, includes an image rotation and “horizontal” (x) and “vertical”(y) offsets. Ideally, when assay device is placed into assay reader 102, the device 104 is placed into the same location and orientation with respect to imaging unit 126, an “expected position” or expected location. In such an ideal situation, every time an assay device 104 is placed into reader unit 102 at the expected position, imaging unit 126 would capture an image 150 depicting device 104 and test strips 140 in the same location relative to the image background. Image after image, borders 154 surrounding the image of assay device 102 would appear the same, i.e., same width, height, etc.; images 141 of individual test strips, in an embodiment, would always appear to be in a precisely vertical orientation, and locations of read windows 158 and 159 within image 150 would always be known based on the predetermined location of such windows relative to image edges 153.

As will be described further below with respect to FIGS. 14A-14E, in practice, when assay device 104 is placed into assay reader unit 102, device 104 may not be placed precisely at the expected position or location and orientation. A user may slightly rotate the device 104, or may somehow displace or offset device 104 in a horizontal or vertical direction from its intended position. Likewise, due to unavoidable manufacturing differences between instances of assay reader unit 102, a device 104 inserted into one instance of assay reader unit 102 may not have the same location and orientation with respect to imaging unit 126 as a device 104 inserted into a second instance of assay reader 102.

In a Cartesian coordinate system, device 104 may be translated or offset slightly in an x (horizontal), or y (vertical) direction. For example, a user may insert assay device 104 into assay reader unit 102 in such a way that a lower, front left corner of the device 104 is not resting fully on a bottom portion of reader unit 102, causing a left side of device 104 to be raised up relative to a lower, front, right corner. In such an instance, the portion of assay device 104 with test strips 140 captured by assay reader unit 102 would appear slightly rotated.

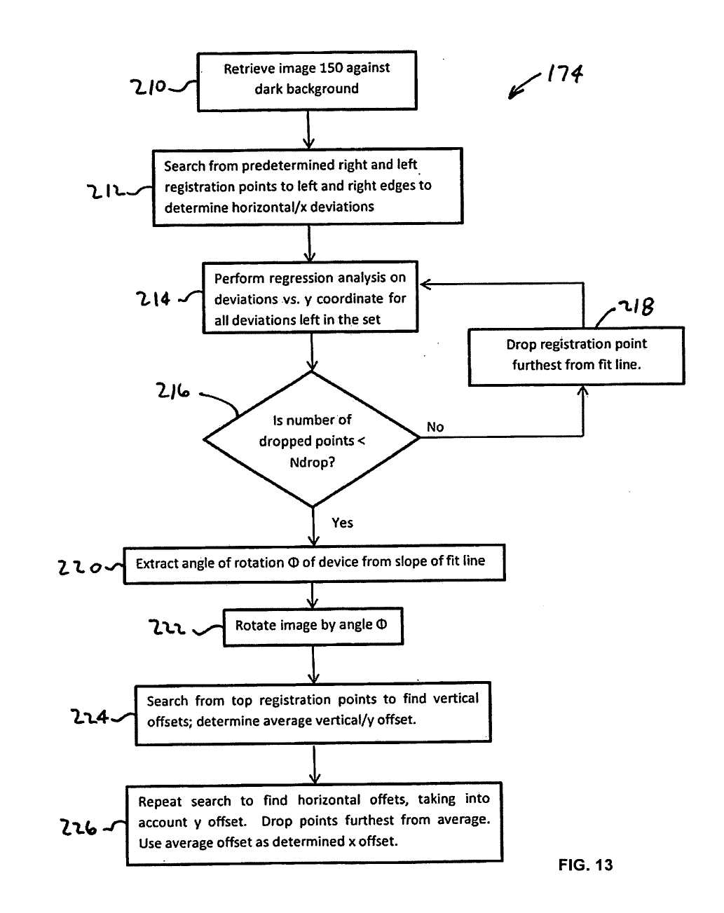

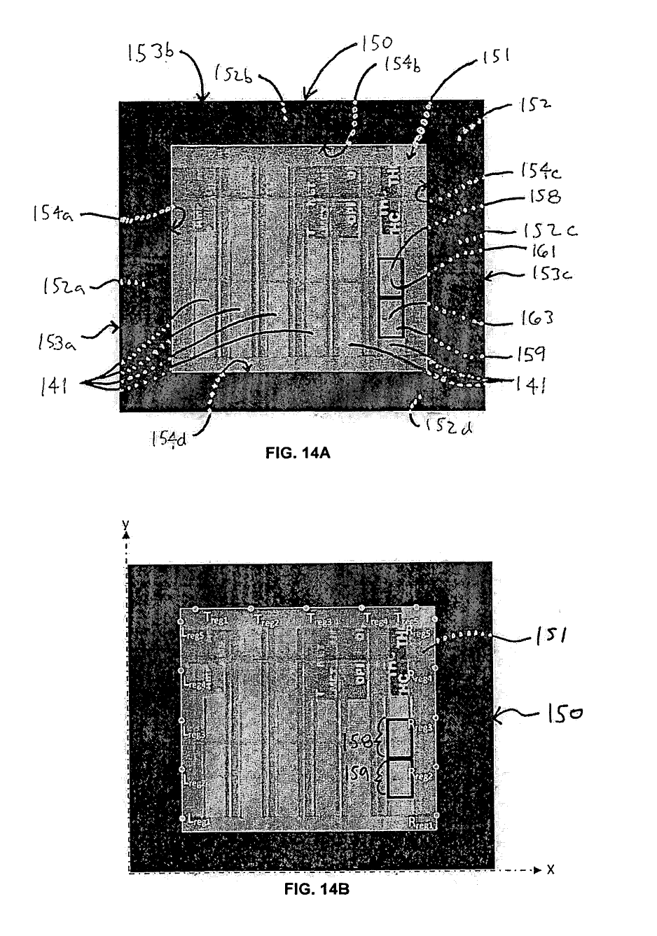

At step 174, deviations in the location and rotation of assay device 104 are measured relative to an expected position, and a rotation offset, horizontal offset, and vertical offset or deviations are determined. Such offsets are used to ensure that appropriate regions, such as read windows 158 and 159, of each test strip 140 are analyzed Step 174 is described further below with respect to FIGS. 13 and 14A-14C. Automatic adjustment for such offsets provides for less expensive manufacturing of assay reader unit 102, as larger manufacturing tolerances and simpler device placement mechanisms are allowable.

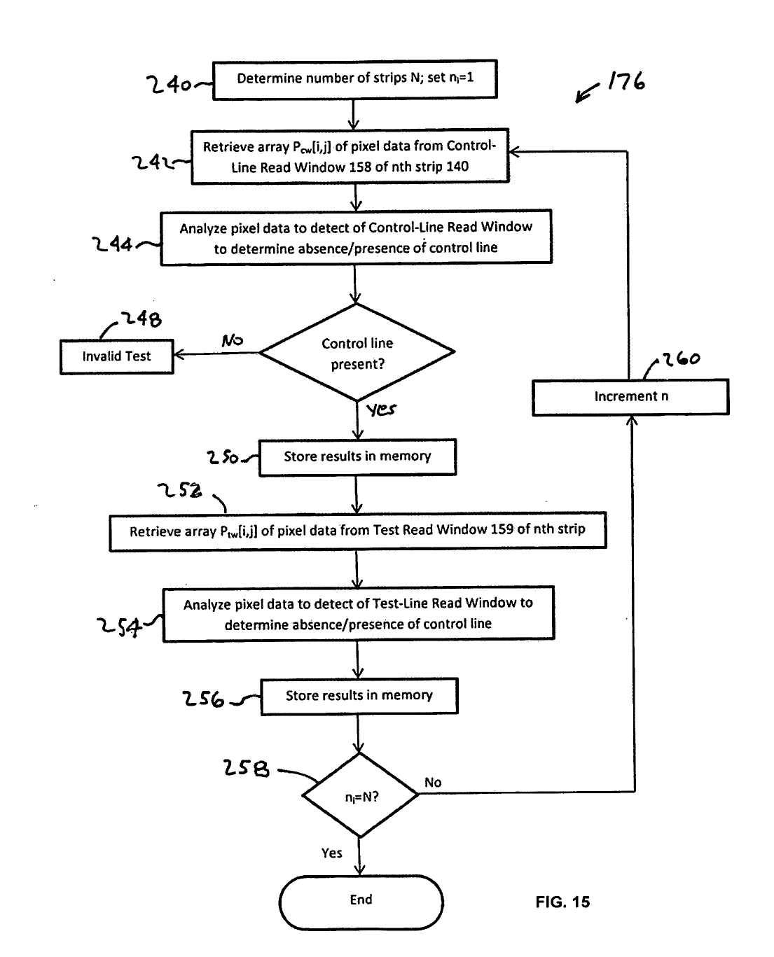

At step 176, pixel data of the averaged device image is analyzed to detect control and test lines for each test strip 140 of assay device 104. Step 176 is described further below with respect to FIGS. 15-18.

At step 178, if all strips are determined to have negative results (a test line 163 is present indicating an absence of the drug of test), then test results are returned at step 180. If all strip test results are not negative, or test lines 163 do not appear on every test strip 140, then at step 182, a predetermined time delay is implemented, or the process is delayed, until the next predetermined point in time, and then steps 168-178 are repeated.

For example, in an embodiment having 6 test strips, steps 168-172 are implemented at first time t=0. Total time for test is 10 minutes. At time t=0, none of the test strips indicate a line. At time t=15 seconds, 4 of 6 test strips indicate negative results (present a test line). Steps 168-172 are repeated. At time t=30 seconds, additional images are taken, steps 168-172 are repeated, and 6 of 6 test strips present a test line, indicating the absence of the six drugs of test. In such an instance, the test is ended prior to the total test time of 10 minutes. On the other hand, if at no point in time do all test strips 140 present a test line, i.e., indicate negative results for each and every test strip, then steps 168-172 are repeated for the entire test time T of 10 minutes. At the end of time T, or 10 minutes in the example, if one or more test strips are positive (no test line present), then the test is terminated, and results returned or presented. In the latter example, the test results would indicate a positive for one drug (presence of the drug), and a negative for the other five drugs.

This “dynamic read” process that constantly reviews the rest results for each and every strip 140 provides great time-saving advantages by terminating the test early if possible. Rather than wait for the entire test time period T, a test can be terminated early if it becomes apparent early in the testing process that no test drugs are present. Such a time savings can be significant when multiple tests are being run consecutively.

Referring again to step 168, and now to FIG. 12, the process identified as “step” 168 of FIG. 11, is depicted and described in further detail.

As described briefly above with respect to FIG. 11, step or process 168 determines and adjusts image exposure, or the amount of light per image unit area. An ideal or at least optimized exposure setting for an image results in improved image 150 detail.

At step 190 of process 168, one or more device-with-background images 150 are captured, and an image array P[I,J] of pixel intensity data is determined in a manner similar to that described above with respect to step 170 and 172 of FIG. 11. In an embodiment where multiple images are captured, pixel data may be averaged to form an image array that includes averaged pixel data, similar to that described above.

When capturing a device-with-background image 150, imaging unit 126 exposes assay device 104 to an amount of light for the purposes of capturing the digital image of device 104. If the light exposure is too much (overexposed), or too little (underexposed), image details are lost, pixel data is compromised, and test results may be inaccurate. Therefore, exposing assay device 104 to an appropriate amount of light affects test quality.

In an embodiment, an ideal image exposure value, or exposure proxy value measured by resultant average image pixel intensity, for each type of assay device 104 that may be received and read by assay reader 104 is predetermined. Ideal image exposures or average image pixel intensities may vary from device to device. For example, some assay devices 104 may employ slightly opaque materials, or only partially transparent materials, which appear as a darker image as compared to transparent materials, such that an ideal image exposure for a dark assay device 104 will be different, or less than, an ideal image exposure for a light assay device 104. Process 168 can account for such differences in assay devices 104, and adjust to reach an ideal exposure, such that the device image 150 quality is optimized, leading to higher quality pixel data, and more accurate test results.

At step 192, in an embodiment, intensity values of all pixels p(i,j) of image array P[I,J] are averaged to determine an average pixel intensity, PI_{avg} for the entire image. In another embodiment, only those pixels associated with device image 151 may be analyzed to determine an average pixel intensity PI_{avg}. Although actual photographic exposure may be measured in units of lux-seconds, average pixel intensity across the entire image serves as a proxy for image exposure, and therefore can be used to adjust the amount of light, or exposure, delivered by imaging unit 126.

At step 194, the measured average pixel intensity PIavg is compared using processor 120 to a predetermined, desired or ideal average pixel intensity for the identified assay device 104. In an embodiment, an ideal average pixel intensity value, or an ideal range for average pixel intensity for the identified assay device 104 is predetermined based upon the characteristics of the particular assay device 104. Such an ideal intensity value or range may be stored in secondary memory 124, or elsewhere, and made available for look up by processor 120 of assay reader unit 102.

At step 196, in an embodiment, if the average pixel intensity of the one or more images PIavg does not fall within the predetermined average pixel intensity range, then at step 198, the exposure of assay device 104 is adjusted upward or downward, depending on overexposure or underexposure, and steps 190 to 196 are repeated until the measured PIavg falls within the predetermined average pixel intensity range, and the process ends at step 200. Although a “range” is indicated, in another embodiment, the measured PIavg must equal the predetermined PIavg.

In an embodiment, measured PIavg must be within +/−5% of the predetermined PIavg; in another embodiment, measured PIavg must be within +/−10% of the predetermined PIavg; in another embodiment, measured PIavg must be within +/−15% of the predetermined PIavg; in another embodiment, measured PIavg must be within +/−25% of the predetermined PIavg; in another embodiment, measured PIavg must be within +/−50% of the predetermined PIavg. Generally, the smaller the range, or the closer that the measured PIavg is to the predetermined PIavg, the better the quality of device image 150.

Referring to FIG. 13, the registration “step” 174 of FIG. 11 is depicted and described in further detail as registration process 174.

As described above with respect to FIG. 11, determining deviations between an actual position of assay device 104 and an expected position of assay device 104, then adjusting for such deviations ensures that appropriate pixels of image 150 are analyzed for the presence of lines 161 and 163.

As also described above with respect to FIG. 11, and in an embodiment, for each known assay device 104 that may be used with assay reader unit 102, one or more of a number of parameters may be known and/or predetermined. In an embodiment, such known parameters include the number and type of test strips 140, the expected location of device-image edges 154 relative to device-with-background image edges 153, relative location of read windows 158 and 159, and relative locations of control and test lines 161 and 163, sizes of read windows 158 and 159 and their respective lines 161 and 163. Such information may be stored in a memory device such as secondary memory 124 or another memory, and retrieved as needed.

Referring also to FIG. 14A, in an embodiment, because imaging unit 126 is fixed relative to a housing or closed shroud 34 of assay reader unit 102, the location and orientation of the image background is fixed. If assay device 104 was always placed into assay reader unit 102 in precisely the same position or location (“expected location”) and orientation test after test, the same amount of background (captured as borders 152) and assay device 104 (captured as device image 151) would be captured to form device-with-background image 150, for each consecutive assay device 104 and test. However, as explained above, when an actual location of assay device 104 deviates from the expected, predetermined position or location, such as is depicted in FIG. 14B, the device image 151 of assay device 104 captured and appearing in device-with-background image 150 appears in a different relative orientation and position relative to background of device image 150. Such a deviation of assay device 104 from its expected position may result in difficulties or errors in searching or detecting control and test tines 161 and 163.

One approach to solving such a problem is to manufacture assay reader units 102 and assay devices 104 with extremely tight dimensional tolerances so as to minimize deviation between actual position and expected position. However, such a solution would result in extremely high manufacturing costs, and would minimize the universal characteristics of assay reader unit 102.

In an embodiment, and as will be described in further detail below, registration process 174 avoids such a dilemma by comparing a position of device image 151 relative to image 150 edges 153 to determine and adjust for deviations in a position of assay device 104 in assay reader unit 102. In an embodiment, system 100 utilizes registration process 174 to analyze device-with-background image 150 to determine deviations between an expected and actual position of assay device 104 by determining an angular rotation of device image 151, then determining horizontal and vertical offsets, relative to an expected location of assay device 104, so as to identify appropriate/translated control and read windows 158 and 159.

Referring specifically to FIG. 13, at step 210, pixel data of averaged image matrix P_{avg}[I,J] may be retrieved or identified for analysis.

At step 212, “horizontal” or x registration points and “vertical” or y registration points are set. Sets of x and y coordinates corresponding to where edges 154 of assay device 104 (or features on a device) are expected to be. Although a Cartesian coordinate system is used to identify x and y registration points, it will be understood that other coordinate systems may be used. In an embodiment, x and y registration points are identified in units of pixels.

Referring also to FIG. 14B, in an embodiment, and as depicted, prior to beginning registration process 174, a Cartesian coordinate system is established with respect to a stored device-with-background image 150 having image 151 at an expected location. In an embodiment, the stored “image” 150 will be understood to be represented by an image reference matrix P_{ref}[I,J]. The Cartesian coordinate system defines a horizontal or x axis and a vertical or y axis, and an origin at a lower left corner of image 150. In an embodiment, each unit of x and y may be equivalent to a pixel. Because image 150 is defined by image reference matrix P_{ref}[I,J]. Consequently, each set of (x,y) coordinates corresponds to a pixel p(i,j) in image reference matrix P_{ref}[I,J] stored in a memory such as memory 124 or another memory device, each pixel having a known, determined pixel intensity value.

Recalling that device-with-background image 150 includes device image 151 positioned at an ideal, expected position, a first set of registration coordinates or points, left-side registration points, are depicted and labeled as L_{reg1}, L_{reg2}, L_{reg3}, L_{reg4} and L_{reg5}. Generally, registration points are depicted in 14B-14F as circular points on image 150. These left-side registration coordinates may be identified in pixel coordinates as the pixels located at p(x₁, y₁), p(x₁, y₂), p(x₁, y₃), P(x₁, y₄) and p(x₁, y₅). For this left-side registration set, the y coordinate value varies, but the x value remains the same. Although five registration points are used in this example, more or fewer registration points may be used in a registration point set. Each registration left-side registration point is at an edge 154a of device image 151, such that a line bisecting all of these left-side registration points would be aligned with left edge 154a.

A second set of registration points, a top-side registration point set, is depicted and labeled as T_{reg1}, T_{reg2}, T_{reg3}, T_{reg4} and T_{reg5}. These top-side registration coordinates may be identified in pixel coordinates as the pixels located at p(x₂, y₆), p(x₃, y₆), p(x₄, y₆), p(x₅, y₆) and p(x₆, y₆). For this top-side registration set, the x coordinate value varies, but the y value remains the same. Although five registration points are used in this example, more or fewer registration points may be used in a registration point set. Each registration right-side registration point is at a top edge 154b of device image 151, such that a line bisecting all of these top-side registration points would be aligned with top edge 154b.

A third set registration points, a right-side registration point set, is depicted and labeled as R_{reg1}, R_{reg2}, R_{reg3}, R_{reg4} and R_{reg5}. These right-side registration coordinates may be identified in pixel coordinates as the pixels located at p(x₇, y₁), p(x₇, y₂), p(x₇, y₃), p(x₇, y₄) and p(x₇, y₅). For this right-side registration set, similar to the right-side registration point set, the y coordinate value varies, but the x value remains the same. Although five registration points are used in this example, more or fewer registration points may be used in a registration point set. Each registration right-side registration point is at an edge 154c of device image 151, such that a line bisecting all of these right-side registration points would be aligned with edge 154c.

In summary, FIG. 14B depicts a reference device image 151 within a larger reference device-with-background image 150, and a registration coordinate system defining an expected position or location of the edges 154 of device image 151. Knowing where each edge 154 is located within image 150 means that a position of each read window 158 and 159 within image 150 can be identified, i.e., that pixels corresponding to each read window, can be identified for analysis.

In some embodiments of assay device 104, edges 153 may not be linear, as depicted, but in other embodiments, edges may not be linear, or even uniform, but rather may be curvilinear or otherwise. As such, registration point sets, while still being selected at an edge or other feature of assay device 104, may not be aligned in a uniform, linear fashion as depicted. Consequently, unlike known assay image analysis techniques, registration process 174 can be used with registration points assigned to nearly any identifiable feature or set of features, thereby accommodate linear, curvilinear, or any sort of edge, or feature. This feature provides great flexibility in terms of the ability of assay reader unit 102 to receive nearly any type of assay device 104.

Further, pixels associated with each control read window 158 and each test window 159 are predetermined and stored based on the known pixel coordinates of each window. In other words, pixels within the area of a read window 158 or 159 are predetermined with respect to a reference image 150 and reference matrix P_{ref}[I,J], such that a read window may be defined by its set of pixels, or by a set of x, y coordinates.

Referring to FIG. 14C, a captured, or “actual” device-with-background image 150 having a device image 151 is depicted. In this image 150, it is apparent that assay device 104 was imaged in a position that is not the same as the expected position. Device image 151 is rotated and translated horizontally and vertically with respect to its expected position. Rotation of device image 151 causes a position of read windows 158 and 159 to be moved relative to image 150 edges 154.

If pixel data was extracted from coordinates defined in reference matrix P_{ref}[I,J] as control read window 158 and test read window 159, error would result as the relative position of each or read windows 158 and 159 has been moved. Consequently, to identify and select the pixels and pixel intensity values to be analyzed for test lines, namely the pixels within read windows 158 and 159, actual image 151 may be re-oriented, as described further below.

Referring also to FIG. 13, at steps 212 to 220, actual image 150 is analyzed to determine an angle of rotation of device image 151.

More specifically, at step 212, searching from left-side (L_{reg}) and right-side (R_{reg}) registration points to left and right edges to determine horizontal or x deviations (Δ_{L} values and Δ_{R} values. In other words, horizontal (x) deviations are determined by locating left, right, or both left and right, edge points/pixels, and determining their position relative to corresponding registration points.

In an embodiment, a horizontal pixel search is conducted by starting at a registration point having a predetermined set of coordinates, holding a y coordinate value constant, then analyzing pixels adjacent the registration point/pixel by varying the x coordinate until an edge pixel is found. In an embodiment, an edge pixel may be identified by using known pixel edge analysis techniques, or in another embodiment, may simply be identified by analyzing the intensity value of the potential edge pixel and comparing it to an intensity threshold. In such an embodiment, an intensity threshold might be near zero, or black, so that any pixel that is brighter than a background pixel is determined to be an edge pixel.

In an embodiment, both left-side and right-side x deviations are determined using left and right registration points. Left-side deviations are identified in FIG. 14C as a set of Δ_{L} line segments comprising Δ_{L1}, Δ_{L2}, Δ_{L3}, Δ_{L4} and Δ_{L5}. Each Δ_{L} value represents a horizontal or x deviation measured in pixels from a left registration point to a left edge. Left-side horizontal deviations Δ_{L1}, Δ_{L2}, Δ_{L3}, Δ_{L4} and Δ_{L5} are measured from left-side registration points L_{reg1}, L_{reg2}, L_{reg3}, L_{reg4} and L_{reg5} to corresponding edge pixels indicated by square points along actual left edge 153a.

Similarly, right-side x deviations are determined. right-side deviations are identified in FIG. 14C as a set of Δ_{R} line segments comprising Δ_{R1}, Δ_{R2}, Δ_{R3}, Δ_{R4} and Δ_{R5}. Each Δ_{R} value represents a horizontal or x deviation measured in pixels from a right registration point to a right edge. Right-side horizontal deviations Δ_{R1}, Δ_{R2}, Δ_{R3}, Δ_{R4} and Δ_{R5} are measured from right-side registration points R_{reg1}, R_{reg2}, R_{reg3}, R_{reg4} and R_{reg5} to corresponding edge pixels indicated by square points along actual right edge 153c.

Although both left-side and right-side horizontal/x deviations, Δ_{L} and Δ_{R} values, are determined in the depicted and described embodiment, in an alternate embodiment, only one of left-side or right side horizontal/x deviations may be determined and analyzed.

At step 214, regression analysis, such as a least-squares analysis, is performed on left-side horizontal deviations Δ_{L} and right-side horizontal deviations Δ_{L} vs. y coordinate to determine a best fit line L. Because deviations are being analyzed, both left-side and right-side deviations can be grouped together in the analysis to determine a line L. The slope of the line L corresponds to an angle of rotation Φ of device image 151. Using both left-side and right-side deviations improves overall accuracy in determining line L and subsequently, a determined angle of rotation Φ.

To improve the accuracy of line L, in an embodiment, steps 216-220 may be performed. In an embodiment of steps 216-220, deviation points furthest from extrapolated line L are dropped and a revised extrapolated line L is determined. In an embodiment, a predetermined number of points N_{drop} may be dropped to improve line and slope accuracy.

More specifically, at step 216 it is determined whether a number of dropped points is less than N_{drop}.

If the number of dropped points is less than N_{drop}, then at step 218, the horizontal deviation, which could be a Δ_{L} or a Δ_{R} value, that is furthest from line L is dropped.

At step 214, a new line L is extrapolated or determined based on the remaining deviation values in the data set.

Steps 214 to 218 are repeated until the number of points dropped is not less than N_{drop}, and a line L having a slope S is determined.

At step 220, as will be understood by those of skill in the art, an angle of rotation Φ is derived from slope S. For example, a slope of 1 corresponds to a 45° angle of rotation Φ.

At step 222, and also referring to FIG. 14D, device-with-background image 150 is rotated by angle of rotation Φ. In an embodiment, image 150 is rotated about a center point or pixel p(x_{c},y_{c}). Those of skill in the art will understand that “rotation” of image 150 is accomplished by rearranging pixel data in image matrix PI_{avg}[I,J] such that the image matrix becomes rotated image matrix Pᵣₒₜ[I,J]. In an embodiment, pixels falling outside frame F will be background pixels, and will simply be eliminated; pixels having data removed and no new data added (those falling into triangular portions A, B, C, and D, will be assigned a default intensity value corresponding to the intensity value of the background.

Referring also to FIG. 14E, rotated image 150 defined by rotated image matrix Pᵣₒₜ[I,J], and including device image 151, is depicted. As is apparent from FIG. 14E, device image 151 is moved in both an x and y direction as compared to device image 151 in an expected position or location (see also, FIGS. 14A and 14B).

Generally, at steps 224 and 226 x and y offsets are determined. An x offset (Offₓ) is the number of pixels that device image 151 is moved in an x direction relative to its expected position, and a y offset (Off_{y}) is the number of pixels that device image 151 is moved in a y direction relative to its expected position. As such, an offset is a distance in pixels from a registration point L_{reg} or R_{reg} (depicted as circular points) to an edge of rotated device image 151, or more specifically, an x offset is the distance in pixels from a left-side registration point in an x direction, holding a y value constant, to a corresponding point at a left- or right-side edge point (depicted as triangular points).

FIG. 14E depicts known registration points Lreg and Rreg overlaid onto rotated image 151, as well as corresponding edge points (triangular points), as will be discussed further below with respect to step 224.

At step 224, vertical or y offsets are determined in a manner similar to that described above for horizontal or x deviations. Y offsets are labeled Off_{y1} to Off_{y5} in FIG. 14E. Off is the distance in a y direction in pixels from registration point T_{reg1} to edge point on edge 153b; Off_{y2} is the distance in a y direction in pixels from registration point T_{reg2} to an edge point on edge 153b and so on.

Also at step 224, y offsets are averaged to find an average y pixel offset, Off_{yavg}. In an embodiment, y offsets further from the average are dropped, and a new average calculated.

At step 226, an average horizontal offset is determined by searching from left and/or right registration points to find horizontal or x offset measured in units of pixels, finding an average horizontal or x pixel offset, then dropping those vertical offsets furthest from the average, followed by finding a new average horizontal offset. In an embodiment, both left and right offsets are determined and averaged together to find an overall average horizontal offset. In another embodiment, only left-side x or horizontal offsets are used to determine an average horizontal offset; in another embodiment, only right-side offsets are determined and used.

The methods and steps described above with respect to step 212 for finding horizontal deviations between registration points and edge points are used at step 226 to determine horizontal offsets.

Left-side x offsets are labeled Offₓ₁ to Offₓ₅ in FIG. 14E. Offₓ₁ (not depicted since indefinite in this example) is the distance in an x direction in pixels from registration point L_{reg1} to edge point on left edge 153a; Offₓ₂ is the distance in an x direction in pixels from registration point L_{reg2} to an edge point on edge 153a and so on. Right-side x offsets are not depicted in FIG. 14E, but it will be understood that right-side x offsets may be determined in a manner similar to that of left-side x offsets, and right-side x deviations.

As will be discussed further below, the x offset and the y offset are used to offset originally-defined read windows 158 and 159, such that pixels in the vicinity of expected lines are analyzed.

As such, the above registration process 174 provides an accurate method of determining horizontal and vertical offsets for the purpose of identifying control and test lines. Further, because multiple deviations between expected and actual or rotated images are analyzed as described above, assay devices 104 or nearly any shape may be used with accurate results.

Referring to FIG. 15, step 176 of FIG. 11, analyzing an averaged read window image to detect control line 161 and test line 163, for each strip 140 in assay device 104, is depicted and described.

At step 240, the number N of test strips 140 is determined, and a value nᵢ is set equal to 1. The number of test strips 140 for a particular assay device 104 is known and stored in a memory device, such as memory 126, which may be accessed by processor 120. In an embodiment, and as depicted in FIG. 14A, image 150 indicates that assay device 104 includes six test strips 140, such that N=6.

At step 242, an array P_{cw}[i,j] of pixel data associated with the nth control read window 158 is retrieved from image matrix Pᵣₒₜ[i,j]. As described previously, the location of read windows 158 and 159 in rotated image matrix array Pᵣₒₜ[i,j] is known, such that the pixels belonging to array P_{cw}[i,j] are also known. In an embodiment, and as described above, each pixel in control read window array Pᵣₒₜ[i,j] is assigned a set of (x,y) coordinates. An average x offset Offxavg is added to the x coordinate and an average y offset is added to the y coordinate of each pixel (x,y) coordinate set defining control read window array Pᵣₒₜ[i,j], so as to arrive at the pixel coordinates for the offset control read window array P_{cw}[i,j].

At step 244, pixel data of the array P_{cw}[i,j] of pixel data associated with the nth control read window 158 is analyzed so as to determine the absence or presence of a control line 161.

As indicated at step 246, in an embodiment, the presence of a control line 161 indicates a valid test, while the absence of a control line 161 indicates an invalid test, as indicated at step 248.

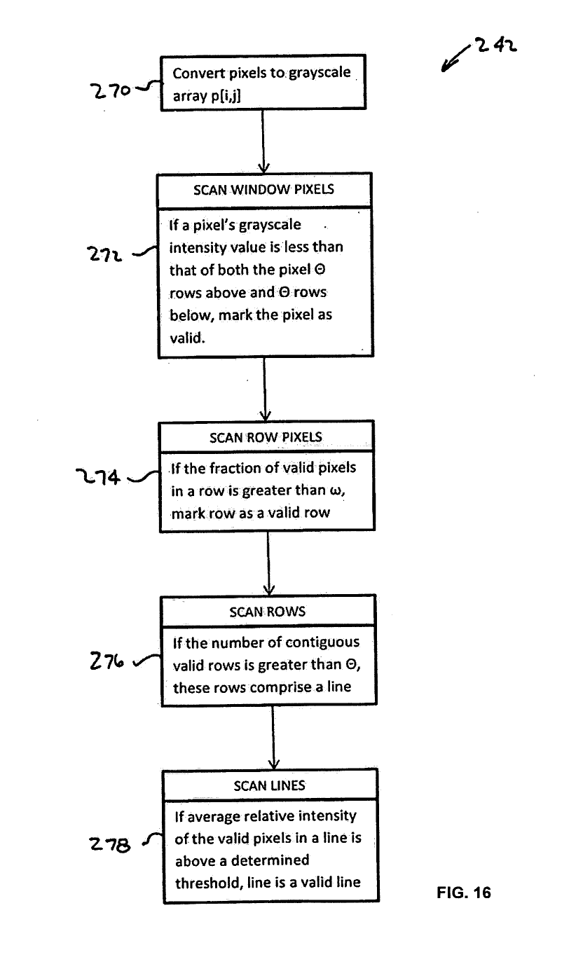

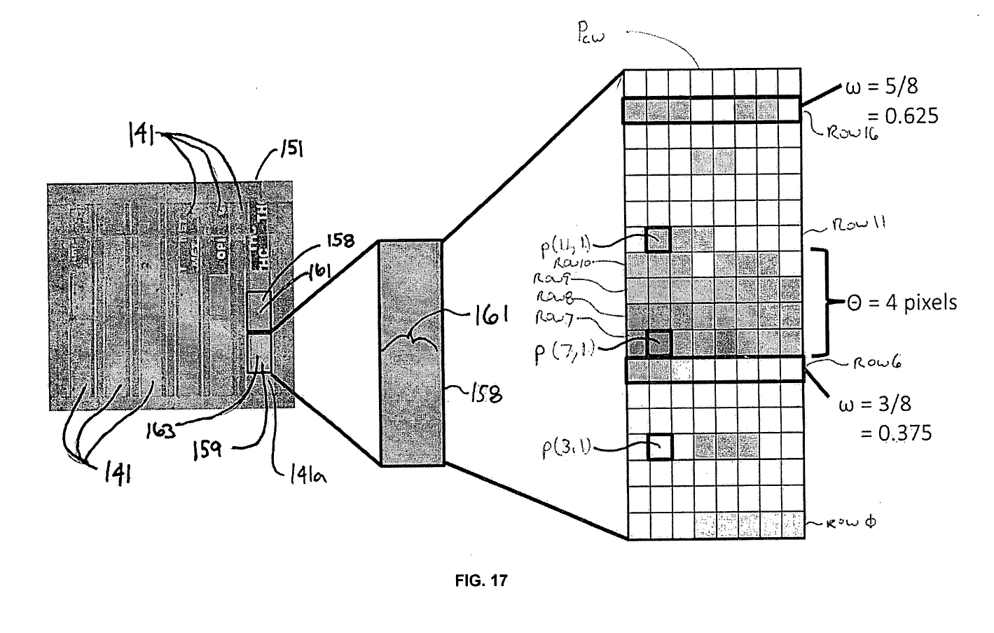

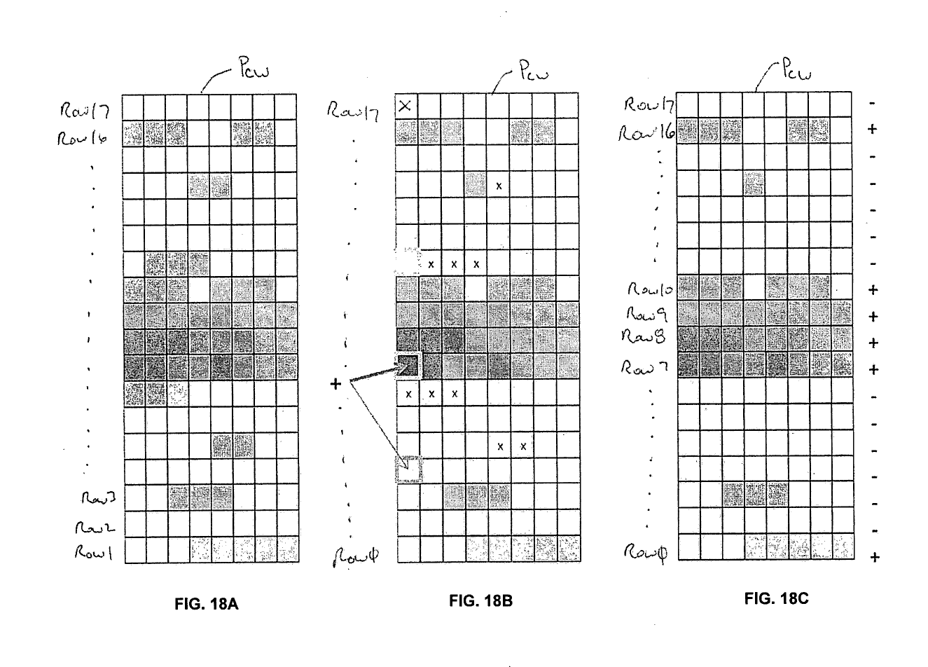

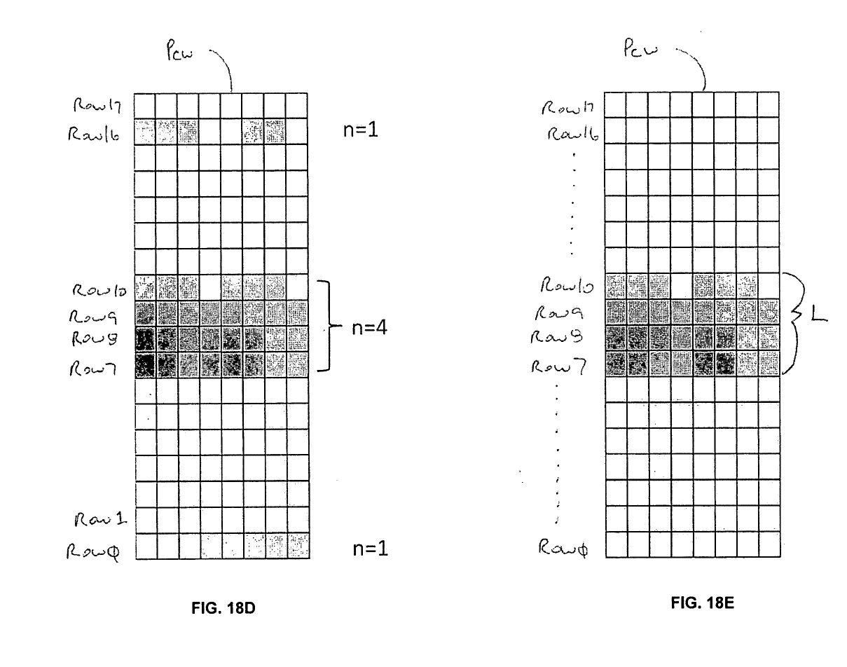

Further details of the analysis of step 244 are depicted and described in the flow diagram of FIG. 16 and additional FIGS. 17 and 18.

At step 250, if a control line 161 is present in the nth control read window, then the results may be stored in memory, such as memory 124, or may otherwise be display, saved or stored.

At step 252, similar to step 242, an array P_{tw}[i,j] of pixel data associated with the nth test read window 159 is retrieved from image matrix Pᵣₒₜ[i,j]. As described previously, the location of read window 159 in rotated image matrix array Pᵣₒₜ[i,j] is known, such that the pixels belonging to array P_{tw}[i,j] are also known. In an embodiment, and as described above, each pixel in test read window array Pᵣₒₜ[i,j] is assigned a set of (x,y) coordinates. An average x offset Offxavg is added to the x coordinate and an average y offset is added to the y coordinate of each pixel (x,y) coordinate set defining test read window array Pᵣₒₜ[i,j], so as to arrive at the pixel coordinates for the offset control read window array P_{tw}[i,j].

In an embodiment, the presence of a test line 163 indicates a negative result (no tested drug present), while the absence of a test line 163 indicates a positive result (tested drug present).

Further details of the analysis of step 252 are depicted and described in the flow diagram of FIG. 16 and additional FIGS. 17 and 18.

At step 256, in an embodiment, the results of absence or presence of a test control line 163 in test window 159 is stored in memory.

At step 258, the value of ni is checked against N, the total number of strips. If ni is not equal to N, then images 141 of additional test strips 140 await analysis. In such case, at step 260 ni is incremented by 1, and steps 242 to 258 are repeated for the next control read window 158 and test control window 159, until all read windows 158, 159 of all test strips have been analyzed.

Referring to FIG. 16, step 244 of FIG. 15 is depicted and described. FIG. 16 describes both steps 244 and 252, since the analysis of a control read window 158 is essentially the same as the analysis of a test read window 159.

At step 270, if not already done, array P_{cw}[i,j] of pixel data associated with the nth control read window 158 is converted to grayscale in an embodiment. Consequently, pixel data in the control read window will comprise a numerical value indicative of intensity, the value, in an embodiment, ranging from 0 to 255, with black conventionally being assigned an intensity value of 0 and white being assigned an intensity value of 255. As such an intensity value of 100 is greater than an intensity value of 99, the value of 100 representing a pixel that is lighter than a pixel having an intensity value of 99.

Generally, at step 272, pixels of array P_{cw}[i,j] are scanned. If a pixel's grayscale intensity is less than that of both a pixel θ rows above and θ rows below, the pixel is marked as “valid”, meaning that the pixel is potentially part of a line 161. If the pixel's grayscale intensity value is greater than either or both of the pixels θ rows above and below, then the pixel is marked as invalid. Step 272, and subsequent steps 274-278 are illustrated in the example embodiment depicted in FIGS. 17 and 18 which will be discussed further below.

At step 274, individual pixels within each pixel row within the read window are scanned (analyzed). If the ratio ω of valid pixels in the row is greater than a predetermined value ω_{ref}, then the row is marked as a valid row. For example, if ω=0.625 and ω_{ref}=0.5, then the row is valid. A value w is predetermined and associated with the identified assay device 104, may be stored in memory 124, and available for look up by processor 120.

At step 276, pixel rows are scanned. If the number of contiguous valid rows is greater than a predetermined value, which in an embodiment is equal to θ, then rows combine to form a unverified line. A value θ is predetermined and associated with the identified assay device 104, may be stored in memory 124, and available for look up by processor 120.

Finally, in an embodiment, identified lines are scanned to determine whether the line is verified or valid. The intensity of the pixels comprising the unverified line are averaged, and if the average intensity in the line is at or below a predetermined threshold, then the unverified line is marked as a valid line. A value for the predetermined average intensity is known and associated with the identified assay device 104, may be stored in memory 124, and available for look up by processor 120.

Although the above is describe with respect to step 244 and pixels in a control read window 158 the above description of FIG. 16 applies equally to step 254 and pixels in a test read window 159.

Referring now to 17H to 18E, an example embodiment of the pixel analysis of process 244 and 254 is depicted and described.

Referring specifically to FIG. 17, step 272, scanning window pixels, is depicted. In this embodiment, device image 151 includes images 141 of six test strips 140. Control read window 158 and test read window 159 are depicted for a first image 141a. It will be understood that the steps and methods described with respect to the read windows of first image 141a are equally applicable to the read windows of the images 141 of the other test strips 140. Further, the description below refers to analysis of pixels in a control read window 158, however, the analysis is also applicable to a control read window 159.

As depicted, control read window 158 is defined by a matrix or array P of pixels. In an embodiment, the matrix of pixels is defined by array P_{cw}[I,J] of rotated image matrix Pᵣₒₜ[I,J], such that matrix P will be referred to as matrix P_{cw} for the sake of illustration. As depicted, matrix P_{cw} includes I rows and J columns, where I=18 and J=8 in this example embodiment.

As described above, in an embodiment, a grayscale intensity of each pixel p(i,j) is compared to an above pixel p(i+θ,j) and a below pixel p(i−θ, j). In this example, θ is set to 4 pixels. Consequently, and in this example, pixel p(7,I) is compared to an above pixel p(11,1) and a below pixel p(3,1). In this example, pixel p(7,1) is darker than either of pixels p(3,1) and p(11,1), such that its corresponding intensity value must be greater than either of pixels p(3,1) and p(11,1). In this simplified example, actual intensity values will generally not be described, as a visual review of the pixel shading in the figures corresponds to grayscale intensity.

Such an analysis is performed for each pixel p(i,j) of matrix P_{cw} until all pixels are either marked valid or invalid. In an embodiment, for those pixels not having a corresponding pixel that is either θ rows above or below, for example, pixel p(9,1), the pixel may be compared only to its below pixel, or its above pixel. In another embodiment, such a pixel is simply marked invalid, and it is assumed that pixels close to the edges of the window do not comprise a portion of a control line 161 or a test line 163.

In a next step, step 274 rows of pixels are scanned or analyzed and marked as valid or invalid. Invalid rows are those rows that do not contain a high enough ratio co of valid pixels. In the depicted example, the fraction or ratio of valid pixels in row 6 is 0.375. When a reference ratio ω_{ref} is set to 0.5 row 6 is an invalid row, though row 16 with an co of 0.625 is a valid row. Rows 7-10 are valid. A further example is illustrated in FIG. 18 below. In an embodiment, the ratio co is in the range of 0.3 to 0.5. In another embodiment the ratio ω is in the range of 0.2 to 0.6.

In a next step, valid rows not belonging to a contiguous group of rows having at least θ rows are eliminated. In this example, rows 6 and 10 are eliminated because they are stand-alone rows.

Finally, the average intensity of remaining “valid” rows 7-10 are each compared to a threshold intensity. In this embodiment, and for the sake of illustration, the average value of each of rows 7-10 is assumed to be above the predetermined threshold intensity, such that the four rows 7-10 comprise a valid line.

The analysis described above may be implement using assay reader system 100.

Referring to FIGS. 18A to 18E, the above steps are depicted in a series of illustrations of a matrix P_{cw}.

FIG. 18A depicts an image matrix P_{cw} having 18 rows and 8 columns.

FIG. 18B depicts the image matrix P_{cw} with some of its pixels marked as invalid as depicted by an “x” in the pixel area. At this stage of analysis as depicted, some pixels have been analyzed, and others have not.

FIG. 18C depicts image matrix P_{cw} with plus and minus signs next to the various rows, a plus (“+”) sign indicating that the ratio of valid to invalid pixels (ω) is equal to or greater than a predetermined ratio (ω_{ref}). In this example, rows 0, 7-11, and 16 are initially determined to be valid.

In FIG. 18D row I groups of contiguous rows are identified and analyzed, and those groups with less than a predetermined group threshold less than θ, which is four in this example embodiment, are eliminated as potential lines, and those groups with θ or more rows in the group are deemed lines. In the depicted embodiment, row 0 comprises a group of one row, and is therefore not a valid line; similarly, row 16 comprises a “group” of I row. However, rows 7-10 comprise a group of four contiguous rows, four being equal to the threshold θ, such that rows 7-10 comprise a line. In FIG. 18D, for the sake of illustration, those pixels not belonging to a line are shown as white.

FIG. 18E illustrates that only remaining rows 7-10 comprise a valid line L.

In summary, apparatuses, systems and methods for universally receiving and automatically reading a wide variety of assay devices is described herein.

At least one non-limiting exemplary aspect can be summarized as a method of to detect the negative, positive, or invalid status of indicator lines on a test strip by analyzing at least one electronic image of the test strip, the electronic image comprising a Cartesian arrangement of pixels, in an assay system to perform assays of test strips, including receiving a number of test strips in an interior of a housing; capturing at least one image of a portion of the interior of the housing in which the test strips are received; computationally identifying individual test strips in the captured image; and computationally performing the negative, positive, or invalid assay evaluation for each of the identified individual test strips that appear in the captured image based at least in part on a representation of at least one indicator line of each of the test strips in the captured image. The captured image can be a high resolution image.

Receiving a number of test strips in an interior of a housing of the assay reader unit can include receiving a plurality of test strips in the housing arranged such that at least a portion of each of a plurality of test strips is exposed to an imaging unit. Capturing at least one image in the interior of the housing can include capturing at least one image of an area in the interior of the housing having a dimension that is greater than a dimension of a single test strip. Capturing at least one electronic image in the interior of the housing can include capturing at least one electronic image of an area in the interior of the housing having a length and a width that is greater than a length and a width of at least two adjacent test strips.

Computationally identifying individual test strips in the captured electronic image can include performing a first iteration of pixel transformation based on a first color of a plurality of pixels in the high resolution image; performing a first iteration of selected pixel rows analysis on a of the plurality of pixels resulting from the first iteration of pixel transformation to identify a first number of selected pixel rows; and performing a first iteration of selected pixel rows pairing on the first number of selected pixel rows identified in the first iteration of selected pixel rows analysis. Computationally identifying individual test strips in the captured image can include performing a second iteration of pixel transformation based on a second color of a plurality of pixels; performing a second iteration of selected pixel rows analysis on a of the plurality of pixels resulting from the second iteration of pixel transformation to identify a second number of selected pixel rows; and performing a second iteration of selected pixel rows pairing on the second number of selected pixel rows identified in the second iteration of selected pixel rows analysis.

The method can further include identifying any machine-readable symbols in the captured high resolution image; and decoding the identified machine-readable symbols, if any. The method can further include logically associating identification information decoded from the identified machine readable symbols with respective test strips which appear in the high resolution image with background. The method can further include storing a respective digital representation of a portion of the captured electronic image of each of at least some of the test strips to a computer-readable storage medium along with at least some identification information logically associated with the respective digital representation of the respective portion of the captured electronic image of each of the at least some of the test strips.

The method can further include storing a respective digital representation of a portion of the captured electronic image of each of at least some of the test strips to a computer-readable storage medium along with at least some information indicative of a result of the negative, positive, or invalid assay evaluation for each of at least some of the test strips logically associated with the respective digital representation of the respective portion of the captured electronic image of each of the at least some of the test strips. The storing can include storing to a removable computer-readable storage medium.

The method can further include computationally performing the negative, positive, or invalid assay evaluation for each of the individual test strips that appear in the captured electronic image based at least in part on a representation of at least one indicator line of each of the test strips in the captured high resolution image. Such can include objectively quantifying an intensity of at least one positive results indicator line on each of the test strips represented in the captured high resolution image. Such can further include evaluating at least one control indicator line on each of the test strips represented in the captured high resolution image, and one test indicator line.

Computationally performing the negative, positive, or invalid assay evaluation for each of the identified individual test strips that appear in the captured electronic image based at least in part on a representation of at least one indicator line of each of the test strips in the captured electronic image can include objectively quantifying an intensity of at least one positive results indicator line on each of the test strips represented in the captured high resolution image.

Computationally performing the negative, positive, or invalid assay evaluation for each of the identified individual test strips that appear in the captured electronic image based at least in part on a representation of at least one indicator line of each of the test strips in the captured electronic image can include evaluating at least one control indicator line on each of the test strips represented in the captured high resolution image.

A configurable criteria can include a threshold level to objectively evaluate the test results indicator line. The at least one configurable criteria can include at least one non-limiting exemplary aspect of a physical format of the test strips of the respective type of test strip. At least two of the configuration modes can be mapped to respective test strips of at least two different types. At least two of the configuration modes can be mapped to respective test strips of at least two different immunochromatographic tests. At least two of the configuration modes can be mapped to respective test strips from at least two different test strip producing commercial entities. The user interface can include indicia indicative of a plurality of different test strip products. The user interface can include at least one input device configured to allow the entry of a subject identifier that uniquely identifies a subject from which a sample on the test strip was taken, and a logical association between the negative, positive, or invalid assay evaluation of the test strip and the subject identifier can be stored. The at least one processor can be configured to perform the negative, positive, or invalid assay evaluation by objectively quantifying an intensity of at least one positive results indicator line on each of the test strips. The at least one processor can be configured to perform the negative, positive, or invalid assay evaluation by evaluating at least one control indicator line on each of the test strips. The entrance can include a plurality of slots, each slot sized and dimensioned to receive a respective one or the test strips therein.

Receiving a user input indicative of at least one value of at least one configurable criteria to be used in performing a negative, positive, or invalid assay evaluation can include receiving a user input indicative of a threshold level for the objective assay evaluation. Receiving a user input indicative of at least one value of at least one configurable criteria to be used in performing a negative, positive, or invalid assay evaluation can include receiving a user input indicative of a threshold intensity level for a positive results indicator line. Receiving a user input indicative of at least one value of at least one configurable criteria to be used in performing a negative, positive, or invalid assay evaluation can include receiving a value indicative of a physical format of the test strips of the respective type of test strip. Receiving a user input indicative of at least one value of at least one configurable criteria to be used in performing a negative, positive, or invalid assay evaluation can include receiving a value indicative of a type of test strip.

Receiving a user input indicative of at least one value of at least one configurable criteria to be used in performing a negative, positive, or invalid assay evaluation can include receiving a value indicative of a test strip manufacturer. Receiving a number of test strips in an interior of a housing can include receiving a plurality of test strips in the housing arranged such that at least a portion of each of a plurality of flow strips is exposed to an imaging unit.

Capturing at least one image in the interior of the housing can include capturing at least one image of an area in the interior of the housing having a dimension that is greater or less than a dimension of a single test strip. Capturing at least one image in the interior of the housing can include capturing at least one image of an area in the interior of the housing, a background, having a length and a width that is greater than a length and a width of at least two adjacent test strips.

The method can further include computationally identifying individual test strips in the captured image. The method can further include receiving a user input indicative of at least one value of at least one configurable criteria to be used in performing a negative, positive, or invalid assay evaluation includes receiving an end user input via a user interface.

At least one non-limiting exemplary aspect can be summarized as a computer-readable medium that stores instructions that cause an assay system to perform assays of test strips, by: receiving a user input indicative of at least one value of at least one configurable criteria to be used in performing an objective assay evaluation; receiving a number of test strips in an interior of a housing; capturing at least one image a portion of the interior of the housing in which the test strips are received; and computationally performing the negative, positive, or invalid assay evaluation for each of the test strips in the captured image based at least in part on a representation of at least one indicator line of each of the test strips in the captured image and based at least in part on the user input indicative of the at least one value of at least one user configurable criteria.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A universal assay reader comprising a base, a shroud, a camera, and an illumination source;
the base having a receiver for receiving sample containers, with assay strips, the receiver have a plurality of form fit patterns for receiving and seating more than one type of configured container.

2. The universal assay reader of claim 1 wherein the receiver is removable and replaced with a differently configured receiver.

3. The universal assay reader of claim 1 wherein the shroud is dome shaped and engages a horizontal engagement surface on the base.

4.-5. (canceled)

6. The universal assay reader of claim 1 wherein the receiver has sensors for detecting which of the plurality of form fit patterns is associated with a sample container in place in the receiver.

7. The universal assay reader of claim 1 wherein the reader is configured to accept at least two of the following set: urine sample containers with at least one assay strip; saliva sample containers with at least one assay strip; and blood sample containers with at least one assay strip.

8. The universal assay reader of claim 1 in combination with a sample container compatible with the receiver.

9.-12. (canceled)

13. A method to detect the negative, positive, or invalid status of one or more indicator lines on a test strip by analyzing at least one electronic image of the test strip, the electronic image comprising a Cartesian arrangement of pixels, in an assay system having at least one processor to perform assays of the test strips, the method comprising:
(a) receiving in an interior of a housing at least one lateral flow test strip comprising at least one sample, the housing having an interior to receive at least a portion of the at least one of said test strip;
(b) capturing using an imaging unit at least one electronic image of at least a portion of said test strip as a read window comprising at least one of said indicator lines, the imaging unit operable to capture electronic images of one or more of the test strips received in the interior of the housing;
(c) computationally identifying, by a processor, individual test strips in the captured electronic image of the test strip, the image comprising high and low intensity pixels, where the low intensity pixels are lighter in color or grayscale and the high intensity pixels are darker in color or grayscale the communicatively coupled to the imaging unit to receive image information representative of the images captured by the imaging unit, the processor configured to:
(i) identify individual test strips, in the image from the image information;
(ii) analyze whether said pixels within the region belongs to a subset as a local intensity optimum of high pixel intensity corresponding to an indicator line, by electronically determining on a processor, sets of pixels in the electronic image within the regions in a vertical or horizontal orientation, provide a sufficient number of contiguous selected pixel sets to identify an indicator line, by determining, electronically on a process, whether the average pixel set intensity above background and relative to adjacent rows of pixels of lower intensity, provides said local intensity optimum corresponding to an indicator line;
(iii) counting, positioning, or orienting each of the distinct local intensity optimums corresponding to one or more distinct indicator lines found within each of the regions;
(d) computationally performing, using at least one processor, a negative, positive, or invalid assay evaluation for each of the identified indicator lines in each of the individual test strips that appear in one or more of the captured electronic images based at least in part on a representation of at least one indicator line of each of the test strips in the captured electronic image; the at least one processor further configured to perform said negative, positive, or invalid assay evaluation based at least in part on at least one indicator line on each of the test strips and based at least in part on at least one configurable criteria to provide one or more of a negative, positive, or invalid assay result for each test strip.

14.-19. (canceled)

20. The assay method of claim 13, wherein capturing at least one electronic image of a portion of the interior of the housing in which the test strip is received comprises capturing a two-dimensional data array, the two dimensional data array including data representative of an image of at least a portion of the sample container and the at least one test strip received in the interior of the housing via a fixed CCD or CMOS image capture device.

21. The method of claim 13, further comprising: identifying any machine-readable symbols in the captured high resolution image; decoding the identified machine-readable symbols, if any; and logically associating identification information decoded from the identified machine readable symbols with respective test strips which appear in the high resolution image.

22. The method of claim 13, further comprising: storing a respective digital representation of a portion of the captured electronic image of each of at least some of the test strips to a non-transitory computer-readable storage medium along with at least some identification information logically associated with the respective digital representation of the respective portion of the captured electronic image of each of the at least some of the test strips.

23. The method of claim 13, further comprising: reading a subject identifier in the form of a piece of biometric information or a piece of government issued identification; and storing a logical association between the negative, positive, or invalid assay evaluation of the test strip and the subject identifier.

24. The method of claim 13, wherein computationally performing the negative, positive, or invalid assay evaluation for each of the identified individual test strips that appear in the captured electronic image based at least in part on a representation of at least one indicator line of each of the test strips in the captured electronic image includes objectively quantifying an intensity of at least one positive, negative, or invalid results indicator line on each of the test strips represented in the captured high resolution image.

25. The method of claim 13, wherein computationally performing the negative, positive, or invalid assay evaluation for each of the identified individual test strips that appear in the captured electronic image based at least in part on a representation of at least one indicator line of each of the test strips in the captured electronic image includes evaluating at least one control indicator line on each of the test strips represented in the captured high resolution image.

26.-37. (canceled)

38. An assay reader system, comprising:
an assay device having a plurality assay test strips; and
an assay reader unit, the assay reader unit including:
a processor;
an imaging unit for imaging a portion of the assay device, the imaging unit communicatively coupled to the processor;
a user interface for receiving input from a user of the assay reader unit, the imaging unit communicatively coupled to the processor;
a memory storing image data associated with the assay device, the memory communicatively coupled to the processor;
wherein the processor is configured to:
identify the assay device;
cause the imaging unit to expose the assay device to light emitted by the imaging unit;
cause the imaging unit to capture and store an image of a portion of the assay device and a portion of a background of the assay device, the background of the assay device comprising a shroud of the assay reader unit, the image defined by a set of pixel data;
perform a registration process to determine an angle of rotation of the assay device within the assay reader device; and
determine an image offset based on the angle of rotation, and use the image offset to determine a subset of pixel data to analyze for the presence or absence of an indicator line.

39. The system of claim 38, wherein the imaging unit comprises one of a camera or a charge-coupled device.

40.-41. (canceled)

42. The system of claim 38, further comprising adjusting a light exposure level based on a predetermined light exposure level.

43. The system of claim 42, wherein the predetermined light exposure level is determined based on characteristics of the assay device.

44. The system of claim 38, wherein the registration process further comprises rotating the image.

45. The system of claim 38, wherein the registration process comprises determining a set of registration points corresponding to an expected position of the assay device.

46. The system of claim 38, wherein the indicator line is one of a control indicator line or a test indicator line.

47.-60. (canceled)
